(19) United States
(12) Patent Application Publication
(10) Pub. No.: US 2003/0156740 A1
(43) Pub. Date: Aug. 21, 2003

(54) Personal identification device using bi-directional authorization for access control

(75) Inventors: Willam G. Siegel, Wellington, FL (US); Gregory L. Cannon, Boynton Beach, FL (US); Thomas Buss, Jupiter, FL (US); George W. McClurg, Jensen Beach, FL (US); Mark Southwick, Lake Worth, FL (US); Richard Irving, Palm Beach Gardens, FL (US); Ron Kropp, West Palm Beach, FL (US); John Vandusen, Jupiter, FL (US); Trent Francis, Hobe Sound, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/283,372

(22) Filed: Oct. 30, 2002

Related U.S. Application Data
(60) Provisional application No. 60/330,794, filed on Oct. 31, 2001.

(51) Int. Cl. G06K 9/00

(52) U.S. Cl. 382/115

(57) ABSTRACT

A system and method are used bi-directional authorization as a security precaution during exchange or transactions of any kind. Identification data (e.g., biometric data, a universally unique identifier (UUID) data, or the like) is authenticated from a first object (e.g., a guardian, a requester, a consumer, a governmental official, a law enforcement official, or the like) and, if verified, then from a second object (e.g., a child, a requestee, a private citizen, a detainee, a product provider, a service provider, or the like). If both sets of identification data are authenticated, then an exchange or transaction for information, people, service, products, or things can take place. In some cases, information about the exchange or transaction is stored locally or remotely to possibly prepare a statistical analysis (e.g., if a law enforcement official is using racial profiling, or the like). The method can further include capturing the identification data of the first object and/or the second object with at least one wireless transceiver biometric device to send the identification data to a device that performs the authenticating step or steps

### RELATED APPLICATIONS

This application claims priority under 35 U.S.C. § 119(e) to U.S. Provisional Application Ser. No. 60/330,794, filed Oct. 31, 2001, which is incorporated herein by reference in its entirety.

### FIELD OF THE INVENTION

The present invention relates generally to a piezoelectric identification device and applications thereof. More particularly, it relates to a device for obtaining biometric information, such as a print, and using the obtained information to recognize and/or identify an individual.

### BACKGROUND OF THE INVENTION

Biometrics are a group of technologies that provide a high level of security. Print capture and recognition is an important biometric technology. Law enforcement, banking, voting, and other industries increasingly rely upon prints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

Optical print scanners are available which detect a reflected optical image of a print. To capture a quality image at a sufficiently high resolution, optical print scanners require at minimum optical components (e.g., lenses), an illumination source, and an imaging camera. Such components add to the overall cost of a print scanner. Mechanical structures to maintain alignment also increase manufacturing and maintenance costs.

Solid-state silicon-based transducers are also available in print scanners sold commercially. Such silicon transducers measure capacitance. This requires the brittle silicon transducers to be within a few microns of the print sensing circuit reducing their durability. To detect a rolled print, the sensing array of the solid-state transducer needs to have an area of 1 inch×1 inch and a thickness of about 50 microns. This is a big geometry for silicon that increases the base cost of a print scanner and leads to greater maintenance costs. Durability and structural integrity are also more likely to suffer in such a large silicon geometry.

In today's society with criminals often using deceit to perform their criminal acts, people have become weary of everyone. This includes police and other governmental officials because criminals often prey on victims using this as their disguise. In addition, criminal are preying on children and kidnaping them by posing as their guardians.

Different approaches have been used to authorize a person for access control. One approach is the rely on a visual recognition. One party, such as a teacher, recognizes another party, such as a parent, and upon recognition releases custody of a child from a school to the parent. This visual approach is limited and difficult to scale of larger number of people. Also, this visual approach can be unreliable.

Another approach is to rely on the presentation of documents or identification information, such as a drivers license, a passport, etc. This provides an additional level of security. However, this is cumbersome as one party must carry documentation, which is burdensome. Also, the other party must be trained to verify the documentation. Further, this type of documentation is vulnerable to forgery.

A still further approach is to capture a biometric, such as a fingerprint (a “print”). Fingerprint technology is very reliable, however print scanners and databases are mainly used in law enforcement, such as at police booking stations. The conventional scanners are expensive and used primarily to enroll suspects and/or convicts. However, print scanners have also be used to enroll other populations, employees, children, etc.

What is needed is a secure, scalable authorization method that is inexpensive and amenable to ubiquitous use by individuals in biometric-level security. The method should provide rapid, low cost, and easy authorization that requires little or no training to secure a variety of transactions.

What is needed is an inexpensive, durable print scanner with low maintenance costs. What is also needed is a device that can quickly and accurately authenticate the identity of two parties before any interaction between the parties takes place.

### BRIEF SUMMARY OF THE INVENTION

Embodiments of the present invention provide a method including the step of authenticating identification data from a first object. After successfully performing the authenticating step of the first object, the method authenticates identification data from a second object. After successfully performing the authenticating of the second object, the method permits the first object to interact with the second object.

In some embodiments, the first and second objects can be a guardian and a child being picked up.

In other embodiments, the first and second objects can be a law enforcement official and a member of the public.

In still other embodiments, the first and second objects can be a consumer and a provider of financial service, products, or other services.

In an embodiment, intangible access control can be used, which can be based on one or more parties replacing government issued identification documents with a wireless transceiver biometric device that can be used to verify identity for law enforcement, guardian access to schools, daycare pick-up of children, and the like.

In another embodiments, tangible access control can be used, which uses information captured at least by a wireless transceiver biometric device for parties during a transaction to both verify identity and that the parties have the qualification and authorization to conduct the transaction.

In an embodiment, the method can further include capturing the identification data of the first object and/or the second object with at least one wireless transceiver biometric device to send the identification data to a device that performs the authenticating step or steps.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates example environments in which the wireless transceiver biometric device of FIG. 1 can be used to complete different types of transactions.

FIG. 7 is a flow chart illustrating an intangible access control application for bi-directional authorization according to embodiments of the present invention.

FIG. 8 is a flow diagram illustrating a law enforcement process as another intangible access control application according to embodiments of the present invention.

FIG. 9 is a diagram illustrating an exemplary transaction between a consumer and a provider using bi-directional authorization according to the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

I. Overview of the Invention

Embodiments of the present invention provide a system and method for using bi-directional authorization (e.g., to give permission for a transaction after an identity or identities are verified) as a security precaution during exchange or transactions of any kind. Identification data (e.g., biometric data, a universally unique identifier (IJUID) data, or the like) is authenticated (e.g., verified) from a first object (e.g., a guardian, a requestor, a consumer, a governmental official, a law enforcement official, or the like) and, if verified (e.g., when a match is found after comparing a submitted biometric sample against a biometric reference template of a single enrollee whose identity is being claimed), then from a second object (e.g., a child, a requestee, a private citizen, a detainee, a product provider, a service provider, or the like). If both sets of identification data are authenticated, then an exchange or transaction for information, people, service, products, or things can take place. In some cases, information about the exchange or transaction is stored locally or remotely to possibly prepare a statistical analysis (e.g., if a law enforcement official is using racial profiling, or the like).

In some embodiments, intangible access control can be used, which can be based on one or more parties replacing government issued identification documents with a wireless transceiver biometric device that can be used to verify identity for law enforcement, guardian access to schools, daycare pick-up of children, and the like. In other embodiments, tangible access control can be used, which uses information captured at least by a wireless transceiver biometric device for parties during a transaction to both verify identity and that the parties have the qualification and authorization to conduct the transaction.

The present invention relates generally to a piezoelectric identification device and applications thereof. More particularly, it relates to a piezoelectric device for obtaining biometric data or information, such as for a print, and using the obtained information to recognize and/or verify the identify of an individual. Print can be any type of print including, but not limited to, a print of all or part of one or more fingers, palms, toes, foot, hand, etc. A print can also be a rolled print, a flat print, or a slap print. The use of the term “data” or “information” throughout the specification can be representative of a biometric, a digital or other image of a biometric (e.g., a bitmap or other file), extracted digital or other information relating to the biometric, etc.

The use of the term “match” or “matching” can be defined as the process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as a one-to-one process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee who template was matched.

II. Wireless Transceiver Biometric Devices

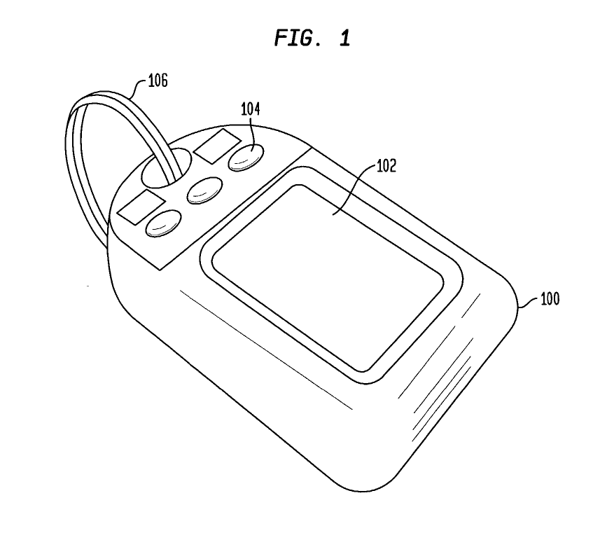

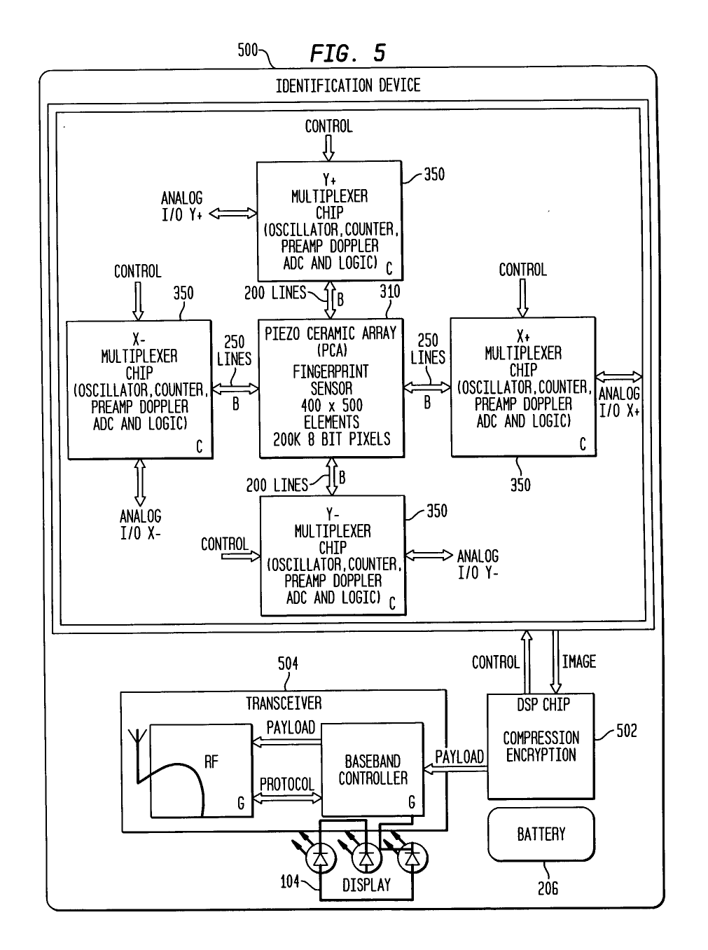

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

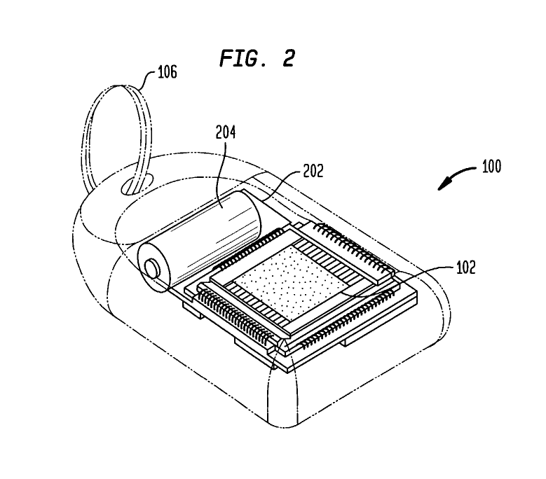

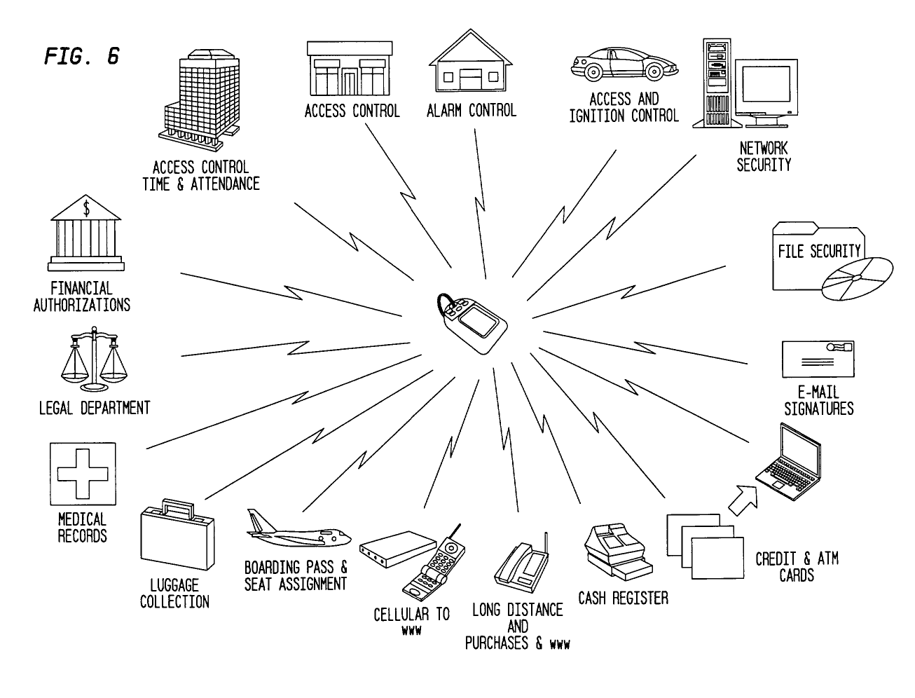

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-9.

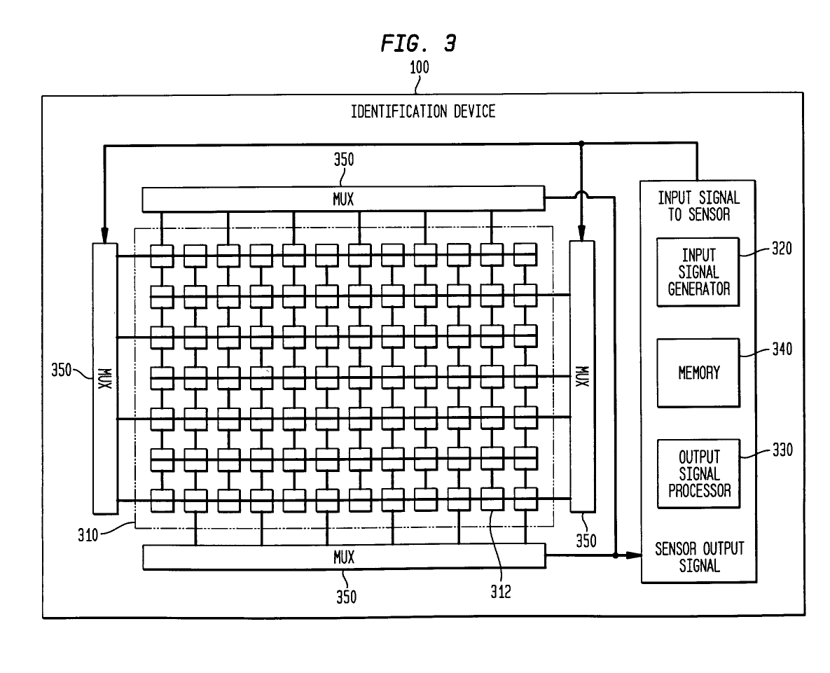

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the 60/330,794 Prov. App, which is incorporated by reference herein in its entirety.

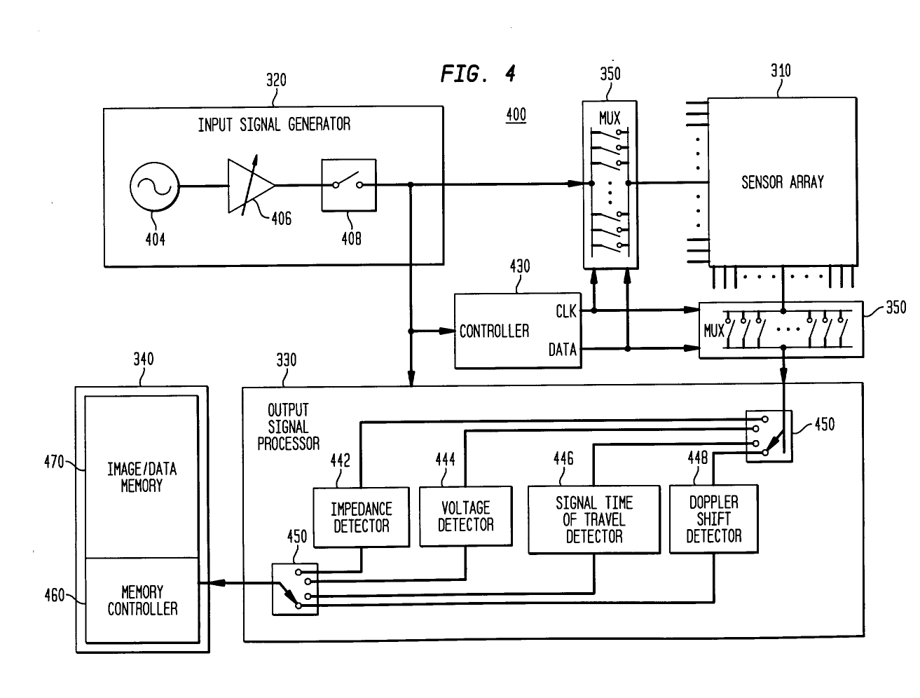

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. 60/330,794, which is incorporated by reference herein in its entirety.

III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can be operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can be operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiverbiometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400,and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 6 illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

D. Bi-Directional Authorization

In some embodiments, wireless transceiver biometric device 100 can operate as a bi-directional authorizer for access control. As a bi-directional authorizer, wireless transceiver biometric device 100 can be used to verify the identity of two or more objects (e.g., people) to authenticate their identities. Authentication of an identity is used to demonstrate rights or ownership to an asset. Authentication of an identity for access control is a way of identifying a person to ensure they have a right to access something.

In some embodiments, a form of access control used is intangible access control. For example, “intangible” can refer to parties using a device, such as device 100, 400, and/or 500, instead of a government issued identification device, such as passport is an access control device for entry into a country and a driver's license is an access control device for enabling a person to use a vehicle on public roads. With intangible access control, both the party of authority and the person proclaiming to have a right of access are required to use the device for authentication to ensure the legitimacy of both parties.

In other embodiments, a form of access control used is tangible access control. This concerns identifying persons to ensure they have a qualifications and authority to perform a transaction. For example, “tangible” can refer to combining using a device, such as device 100, 400, and/or 500, and using signed, legal documents, which may include, but are not limited to, agreements, contracts, wills, codicils acknowledgments, stock purchases, payments, transfer of goods, etc. With tangible access control, both the consumer and the provider are required to use the device for authentication and legal documents for qualification and authority, which ensures the legitimacy of both parties involved in the transaction. For example, prior to consummating a stock transaction between an investor and a stockbroker, the stockbroker must rely on the legitimacy of the investor identity and the investor must be assured that the broker is in good standing with both the broker's company and any broker licensing agency.

1. Example Intangible Access Control Application

Bi-directional authorization can be used as a replacement for a driver's license, passport, Visa, social security card, tickets, etc. In various embodiments of the invention, bi-directional authorization can be used for intangible access control applications, such as law enforcement, guardian access to schools and daycare (to allow the appropriate guardian to pick up the appropriate children from school, daycare), etc.

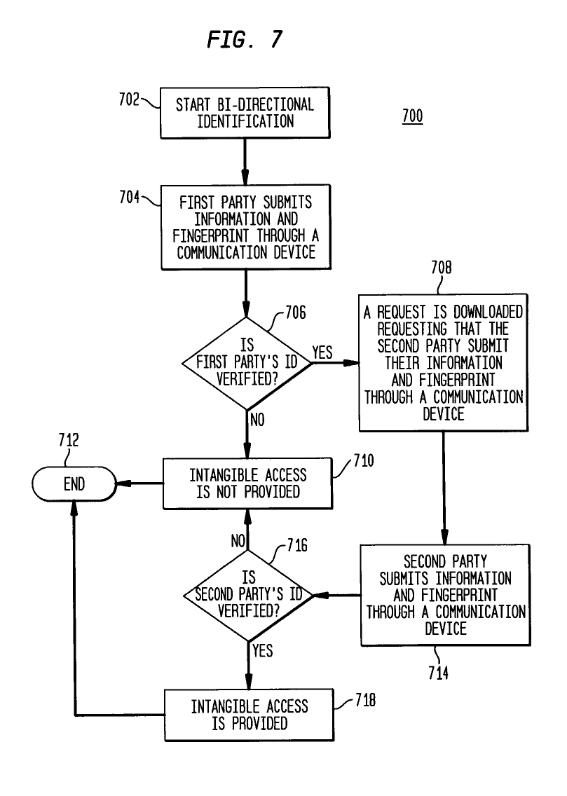

FIG. 7 is a flow diagram illustrating an intangible access control application for bi-directional authorization according to embodiments of the present invention (steps 702-718). In step 702, the identification process begins. In step 704, a first party submits his/her print through his/her wireless transceiver biometric device 100 to an access control center. In one embodiment, the access control center can be a third party verification service. In another embodiment, the access control center can be a government verification agency.

Upon receiving the first party's print and information, the access control center uses the received print to verify the identity of the first party by matching the received print to print data stored in a database. In step 706, it is determined whether the first party's identification has been verified. Information indicating the legitimacy (e.g., the genuineness) of the first party is downloaded. If it is determined that the first party's identification is not legitimate, in step 710 tangible access is not provided, and the process ends in step 712. If the first party's identification is legitimate, in step 708 a request for a second party to submit his/her information and print is downloaded.

In step 714, the second party submits his/her print through his/her wireless transceiver biometric device 100 to the access control center. In one embodiment, the access control center may be a different access control center from the one used by the first party. Upon receiving the second party's print and information, the access control center uses the received print to verify the identity of the second party by matching the received print to print data stored in a database. In step 716, it is determined whether the second party's identification has been verified. Information indicating the legitimacy of the second party is downloaded. If the second party's identification is legitimate, in step 718 intangible access is provided and the process ends in step 712. If it is determined that the second party's identification has not been verified, the process proceeds to step 710 where access is not provided.

Thus, in the case of guardian access to schools, daycare, etc., if the first party's representation as the child's guardian is verified, and the second party's representation as the child of the guardian is verified, the child will be released to the guardian.

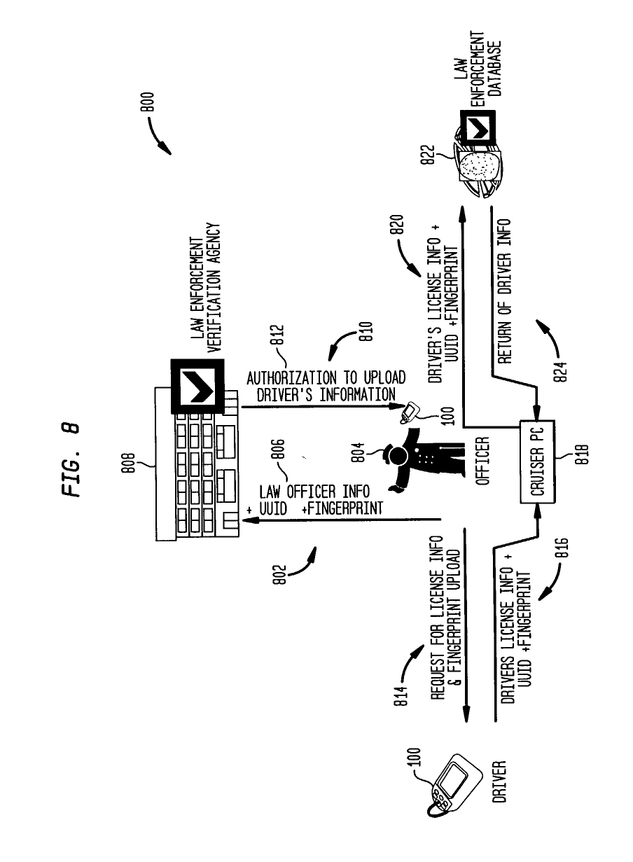

FIG. 8 is a pictorial flow diagram illustrating a law enforcement process 800 as another intangible access control application embodiment of the present invention. The flow diagram illustrates the procedure that would occur for a law enforcement traffic stop where both parties are required to authenticate his/her identification. In step 802, a law enforcement officer 804 submits data (e.g., his/her law officer information, universally unique identifier (UUID) (e.g., a unique 128 bit long identifier that is unique across a combination of time and space fields), and print 806) through his/her wireless transceiverbiometric device 100 to a law enforcement verification agency 808 for the jurisdiction in which the traffic stop was made. Upon receiving the print, UUID, and law officer information from law enforcement officer 804, the law enforcement verification agency 808 uses the received print to verify the identity of law enforcement officer 804 by matching the received print to print data stored in a database. In step 810, if law enforcement officer 804 is deemed legitimate (i.e., ID verified, controlling jurisdiction verified, etc.) by the law enforcement verification agency 808, code 812 is downloaded to indicate that the driver's information can now be uploaded. In step 814, the driver submits his/her print and request for license information via the driver's wireless transceiver biometric device 100. In step 816, the driver's license information, UUID, and print are subsequently uploaded to a law enforcement cruiser PC 818. In step 820, the information is transmitted to a law enforcement database 822, such as an automated printing identification system (AFIS) database. In step 824, the driver's print is then processed by the AFIS database and data on the driver is sent to the law enforcement officer via the cruiser PC.

Accordingly, bi-directional authorization may drastically shorten the length of time of the traffic stop, which decreases the chance of injury or death from other traffic due to the roadside traffic stop. An officer 804 can also automatically upload information on each driver for import into various reports via law enforcement cruiser PC 818, be assured that the information captured accurately reflects information uploaded from the device, and be able to focus on the situation at hand.

Embodiments of the present invention can also collect data for each intangible access control application. This data may be used to show trends. For example, data from the authenticated identification could be uploaded into a processor for future use. In the case of law enforcement, for example, racial profiling is a problem. With the use of bi-directional authorization, in which both officer and driver are required to authenticate his/her identities using a biometric identification, officers may be less likely to make a traffic stop based on race because the information from the traffic stop will accumulate statistics that may tie the law enforcement officer to a civilian inquiry request based on race.

2. Tangible Access Control

As discussed above, tangible access control deals with two or more people involved in a transaction, wherein each party involved wants reassurance that the person or persons they are dealing with have the appropriate qualifications and authorization to conduct the transaction. The term “transaction” is very general and can cover just about every human interaction from a conversation to a contract. Varying levels of identity security are needed depending on the activity, from granting the purchase of a coke from a wireless wallet to the transfer of life savings. The value of the conveyance in the transaction can dictate the level of identity assurance required. Sometimes, the higher the assurance required the greater the effort and time required. In various embodiments transactions can include agreements, contracts, wills, codicils acknowledgments, payment, transfer of goods, etc.

Placing pen to paper and writing a signature provides only the nonreputable function and not the identity identification function. Using a government standard approved biometric identification, such as a print, will supply the non-reputable function and the identification function to ensure a secure transaction.

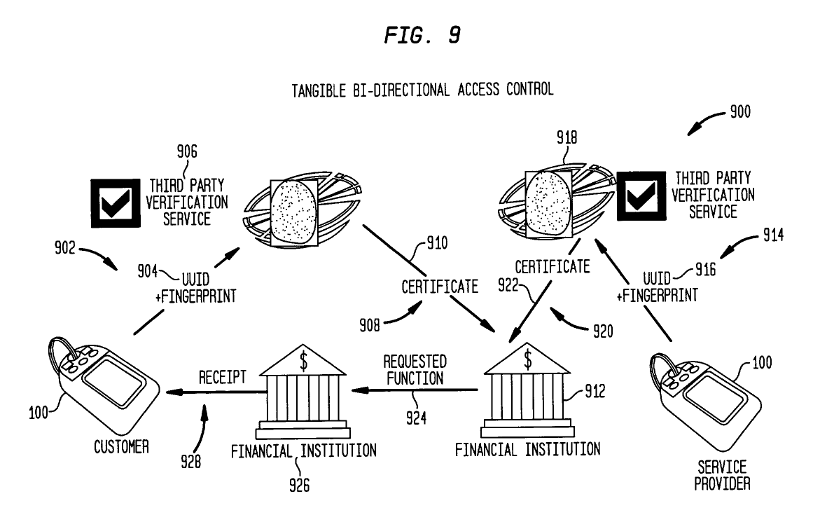

FIG. 9 is a pictorial diagram illustrating an exemplary transaction 900 between a consumer and a provider using bi-directional authorization according to embodiments of the present invention. In step 902, a customer submits data (e.g. a UUID and his/her print) 904 into his/her wireless transceiver biometric device 100. This information is transmitted to a third party verification service 906. The third party verification service 906 receives the print and UUID and uses the received print to verify the identity of the customer by matching the received print to print data stored in a database. In step 908, information related to the customer's identity and the customer's legitimacy to perform the transaction is transmitted from third party verification service 906 in the form of a certificate of authentication 910 to a financial institution 912 related to the transaction taking place.

In step 914, the service provider submits data (e.g., a UUID and print) 916 to the third party verification service 918 using the service provider's wireless transceiver biometric device 100. In one embodiment, third party verification service 918 can be the same verification service as third party verification service 906. In another embodiment, this party verification service 918 can be a separate verification entity. Third party verification service 918 receives the print and UUID 916 and uses the received print to verify the identity of the service provider by matching the received print to print data stored in a database. In step 920, information related to the service provider's identity and legitimacy to perform the transaction is transmitted from third party verification service 918 in the form of a certificate of authentication 922 to financial institution 912. In step 924, if both the customer and the service provider meet the required qualifications, the transaction will transpire. This can be by using financial institution 926. In some embodiments, financial institution 926 can be a same entity as financial institution 912, while in other embodiments financial institution 926 can be a different entity. In step 928, documentation of the transaction is provided to the customer. In some embodiments, information pertaining to the transaction may be collected to show trends and leads to market knowledge, such as purchasing trends, promotions, etc.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method comprising the steps of:
authenticating identification data from a first object;
after successfully performing said authenticating step of the first object, authenticating identification data from a second object; and
after successfully performing said authenticating of the second object, permitting the first object to interact with the second object.

2. The method of claim 1, wherein said interacting step comprises allowing a first object that is a guardian to obtain custody of the second object that is a child at a school or day care.

3. The method of claim 1, wherein said interacting step comprises allowing the first object that is a law enforcement official to obtain information from the second object that is a member of the public.

4. The method of claim 1, wherein said interacting step comprises allowing the first object that is a requestor to gain control of as aspect of the second object that is a requestee.

5. The method of claim 1, wherein said interacting step comprises performing a financial transaction between the first object that is a consumer and a second object that is a provider.

6. The method of claim 1, wherein said interacting step comprises performing a product transaction between the first object that is a consumer and the second object that is a provider.

7. The method of claim 1, wherein said interacting step comprises performing a service transaction between a first object that is a consumer and the second object that is a provider.

8. The method of claim 1, wherein the identification data from the first and second objects is biometric data and a universally unique identifier (UUID).

9. The method of claim 8, wherein the biometric data is a print.

10. The method of claim 1, further comprising the steps of transmitting the identification data of the first and second objects to a remote location to perform said authenticating steps.

11. The method of claim 10, wherein said transmitting is done via a wireless network.

12. The method of claim 1, further comprising the step of storing information about said interacting step.

13. The method of claim 12, further comprising the step of generating results based on the stored information.

14. The method of claim 13, wherein said generating results comprises the step of generating statistical results.

15. The method of claim 14, further comprising the step of determining if the first object that is a law enforcement official is using racial profiling to perform said interacting step with the second object that is a member of the public.

16. The method of claim 1, further comprising the step of capturing the identification data of the first object with a wireless transceiver biometric device to send the identification data to a device that performs said authenticating step.

17. The method of claim 1, further comprising the step of capturing the identification data of the second object with a wireless transceiver biometric device to send the identification data to a device that performs said authenticating step.

18. The method of claim 1, further comprising the step of capturing the identification data of the first object and the second object with at least one wireless transceiver biometric device to send the identification data to a device that performs said authenticating steps.
